(19) United States
(12) Patent Application Publication
(10) Pub. No.: US 2009/0204580 A1
(43) Pub. Date: Aug. 13, 2009

(54) SELECTIVELY OBSCURING THE PRESENTATION OF RESTRICTED DATA ITEMS

(76) Inventors: Joseph Socrates Seamon, San Jose, CA (US); Heiner Kroke, Kleinmachnow (DE); Craig Miller, Toronto (CA)

Correspondence Address: SCHWEGMAN, LUNDBERG & WOESSNER/EBAY, P.O. BOX 2938, MINNEAPOLIS, MN, 55402, US

(21) Appl. No.: 12/142,615

(22) Filed: Jun. 19, 2008

Related U.S. Application Data
(60) Provisional application No. 61/027,905, filed on Feb. 12, 2008.

(51) Int. Cl. G06F 17/30; G06F 3/048

(52) U.S. Cl. 707/3; 715/764; 707/E17.014

(57) ABSTRACT

A computerized method and system for obscuring adult advertisements are provided. Example embodiments may include receiving a search criterion and locating multiple data items using the search criterion. The method may include determining that a subset of the multiple data items has determinable characteristics. The multiple data items may be presented to a user such that each data item of the subset of the multiple data items is uniquely presented and the content of each data item is at least partially concealed.

### CROSS REFERENCE TO RELATED APPLICATIONS

This is a non-provisional patent application claiming priority under 35 USC §119(e) to U.S. Provisional Patent Application No. 61/027,905 entitled “SELECTIVELY OBSCURING THE PRESENTATION OF RESTRICTED DATA ITEMS” that was filed on Feb. 12, 2008, and which is incorporated by reference in its entirety.

### TECHNICAL FIELD

Example embodiments relate generally to the technical field of data management, and in one specific example, to a system and a method for obscuring of adult advertisements.

### BACKGROUND

More and more, Internet users are realizing the ease and convenience of online publication. As a result, collectors, hobbyists, small dealers, unique item seekers, bargain hunters, and other consumers are able to publish transaction listings and advertisements resulting in successful transactions on millions of items and services at various online publication systems, e.g., EBAY INC. of San Jose Calif.

The success of an online publication system depends upon its ability to provide an enjoyable user interaction and an easy-to-use environment in which user may be able to publish data including transactions listings and advertisement. The online publication system may also benefit from providing users with a variety of options, for example, listing their transaction data under diverse categories.

### BRIEF DESCRIPTION OF THE DRAWINGS

Some embodiments are illustrated by way of example and not limitation in the figures of the accompanying drawings in which:

FIG. 1 is a high-level diagram depicting, in an example embodiment, functionality of a system for obscuring of restricted content;

FIG. 2 is a block diagram illustrating an example embodiment of a system for obscuring of restricted content;

FIG. 3 is a block diagram illustrating, in an example embodiment, components of an identification module;

FIG. 4 is a high-level flow diagram illustrating an example method for obscuring of restricted content;

FIG. 5 is a flow diagram illustrating an example method for obscuring of restricted content;

FIG. 6 is high-level block diagram illustrating an example embodiment of a network-based publication system enabled for obscuring of restricted content, having a client-server architecture;

FIG. 7 is block diagram illustrating an example embodiment of tables used by the databases of the network-based publication system of FIG. 6;

FIG. 8 is an example set of publication and obfuscation applications used by the network-based publication system of FIG. 6;

FIG. 9 is a block diagram illustrating a diagrammatic representation of a machine in the example form of a computer system;

FIG. 10 is a screen shot illustrating an example embodiment of a page for posting advertisements in a publication system;

FIG. 11 is a screen shot illustrating an example embodiment of a page for browsing advertisements in a publication system; and

FIG. 12 is a screen shot illustrating an example embodiment of a page for viewing selected advertisements in a publication system.

### DETAILED DESCRIPTION

Example methods and systems for obscuring of undesirable or restricted content (e.g., adult advertisements) have been described. In the following description, for purposes of explanation, numerous specific details are set forth in order to provide a thorough understanding of example embodiments. However, it will be evident to one skilled in the art that the present invention may be practiced without these specific details.

Some example embodiments described herein may include receiving a search criterion and locating multiple data items using the search criterion. The method may include determining that a subset of the multiple data items has determinable characteristics. The multiple data items may be presented to a user such that each data item of the subset of the multiple data items is uniquely presented and the content of the each data item is at least partially concealed.

Accordingly, as opposed to preventing an advertisement with offensive content from displaying entirely, example methods described in this application may be used to uniquely present each advertisement, regardless of the content, by partially or fully concealing the advertisements that have determinable characteristics, but nonetheless presenting information identifying the advertisement to the user. In this way, the user can be alerted to the existence of the advertisement (or other content) while not actually being exposed to the content until, for example, certain restriction prerequisites have been fulfilled.

In an example embodiment, receiving a search criterion may comprise receiving a search query from a user of an online publication system (e.g., KIJIJI.COM, a subsidiary of EBAY INC., of San Jose, Calif.). The search query may include keywords and logical constructs as is well known in the field of data retrieval.

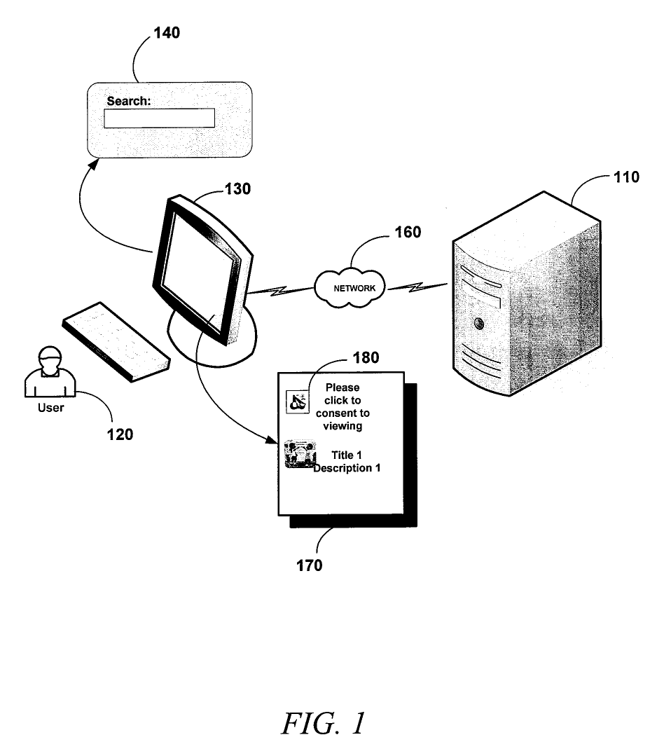

FIG. 1 is a high-level diagram depicting, in an example embodiment, functionality of a system for obscuring of restricted content (e.g., adult content). A user 120 by way of a client machine 130, using a user interface 140, may enter in a search criterion (e.g., a keyword). The client machine 130 may be linked via a network 160 (e.g., the Internet), to a server 110 of an online publication system. The server 110 may receive the search criterion and locate multiple data items (e.g., listings of products or services, advertisements, and the like), using the search criterion. The publication system may determine that a subset of the located data items have determinable characteristics that identify the content as restricted or to which access is or should be controlled.

According to example embodiments, having determinable characteristics may include having potentially offensive content (e.g., adult content, content insulting to certain groups of population, etc.) or potentially illegal content (e.g., defamation, advertising of illegal items, calling for illegal activities, and the like). A pay-per-view (PPV) item may also be considered to have determinable characteristics. In addition, the publication system may flag certain publications, for example, a listing that is entered by a seller who has a history of posting listings with adult content under a non-adult category. In general, all listings under certain categories, as well as flagged listings, may be considered to have determinable characteristics.

In an example embodiment, the server 110 may provide a user interface 180 to present the located data items to user 120. The user interface 170 may present the data items in such a way that each data item of the subset of the multiple data items (e.g., the listings having determinable characteristics) is uniquely presented, (e.g., as a separate listing and simultaneous with other listings) and the content of each data item (e.g., the listings with determinable characteristics) is at least partially concealed or obfuscated. Of course the entire content of a data item may be concealed or obfuscated

According to example embodiments, the concealment or obfuscation of a data item may include obscuring an image 180 contained in the content of the data item. The user interface 170 may obscure the image by, for example, distorting the image or by replacing the image with a generic title and a generic message. The generic title may alert a viewer (e.g., the user 120) that the data item (e.g., the listing or the advertisement) may contain adult content. The generic message may notify the viewer of an image characteristic (e.g., adult content, illegal content, etc.) and may provide a link to consent to viewing of the image by the viewer. The link may, among other things, confirm that the viewer is older than eighteen and is willing to see the content. The link may confirm that viewer is an adult by requesting a credit card number from the viewer. Where the advertisement is for a pay-per-view item, the message may ask the viewer to consent to payment.

One of the unique features of the presentation of the data items of the subset (e.g., the data items having determinable characteristics) may include displaying each of such data items in a partially concealed manner and intermixed with other data items, as opposed to not showing them or just showing all of them under a single title. In other words, as described above, the user interface 180 may display each data item with a title and a descriptor, regardless of the content. The only difference for the data items with determinable characteristics, as discussed above, is that such data items are presented with the generic title and message describe above, rather than being normally displayed.

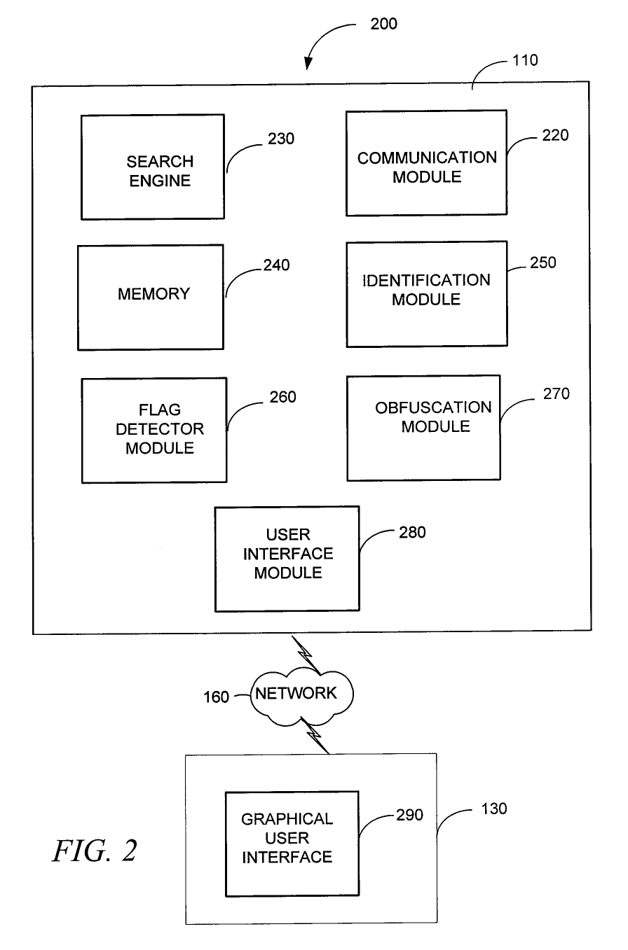

FIG. 2 is a block diagram illustrating an example embodiment of a system 200 for obscuring of restricted content (e.g., adult content). The system 200 (e.g., a publication system) may include the server 110 and the client machine 130 linked via a network 160, e.g., the Internet. The server 110 may include a communication module 220, a search engine 230, a memory 240, an identification module 250, a user interface module 280, an obfuscation module 270, and a flag detector module 260. The client machine 130 may include a graphical user interface 290. The graphical user interface 290 may include the user interfaces 140 and 180.

In an example embodiment, the communication module 220 may receive a search criterion (e.g., a keyword) from the graphical user interface 290, entered by the user 120 (see FIG. 1). The communication module 220 may pass the search criterion to the search engine 230, which may search the memory 240 and locate one or more data items related to the search criterion. The memory 240 may store information related to multiple items categorized in multiple categories. The categories in a publication system such as KIJIJI.COM (a subsidiary of EBAY INC. of San Jose Calif.), for example, may include “for sale,” “community,” “services,” “housing,” “jobs,” and/or “personals.” Some of the categories, for example, “personals,” may include data items having determinable characteristics, such as containing adult content.

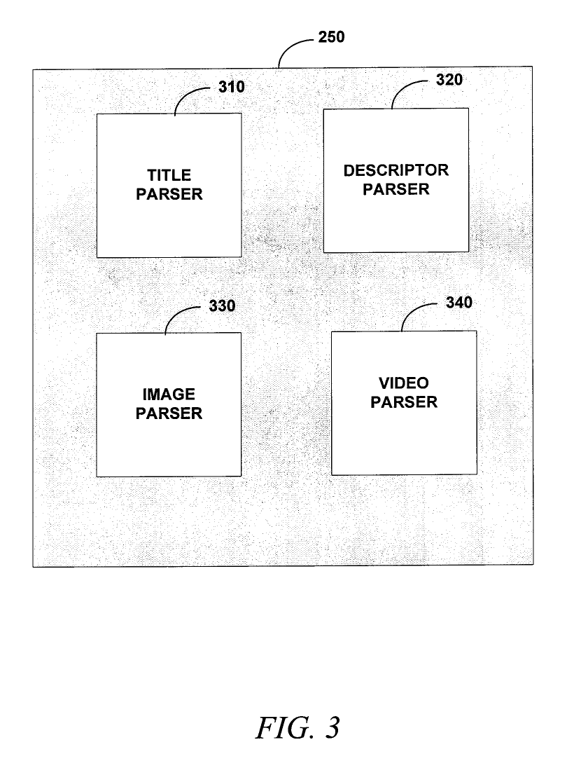

According to example embodiments, the search engine 230 may pass the located data items to the identification module 250, where a subset of data items having determinable characteristics (e.g., having potentially offensive or illegal content, being pay-per-view, flagged, or categorized as potentially offensive or illegal listings) are identified. The identification module 250, described in FIG. 3, may include a title parser 310, a descriptor parser 320, an image parser 330, and a video parser 340. The identification module may use the title parser 310 and the descriptor parser 320 to parse titles and descriptors of data items to determine whether the title or the descriptor includes certain words that might indicate that the data item belongs to a subset having determinable characteristics. The title parser 310 and the descriptor parser 320 may use technologies such as optical character recognition (OCR) or optical mark recognition (OMR) to recognize content.

In example embodiments, wherein the identification module 250 identifies an image or a video contained in a data item, the identification module may use the image parser 330 or the video parser 340 to determine whether such image or video has determinable characteristics (e.g., contains adult content.) The image parser 330 and the video parser 340 may utilize sophisticated technologies including pattern recognition to index images and videos by their visual content.

Returning to FIG. 2, the flag detector module 260 may be used to detect whether a data item is flagged by the publication system. A data item may be flagged, for example, if the poster of the data item shows a history of posting one or more listings containing potentially offensive or illegal content in an unrelated category (e.g., a category which is not designated for such listings). The flagged data item may be identified by the identification module 250 as having determinable characteristics.

After the identification module 250 determines that a data item belongs to the subset having determinable characteristics, the obfuscation module 270 may generate partially concealed content for the data items belonging to the subset. The obfuscation module 270 may generate the partially concealed content of the data item including an image by obscuring the image, or by replacing the image with a generic message. The generic message may notify a viewer of an image characteristic (e.g., showing potentially offensive or illegal content) and may provide a link to consent to viewing of the image by the viewer, e.g., the user 120.

In example embodiments, the obfuscation module 270 may replace a descriptor of the data item with a generic message notifying a viewer of the determinable characteristic and providing a link to consent to viewing of the content of the data item before the graphical user interface 290 displays the data item. The link may request a credit card number from the viewer to confirm that the viewer is an adult before the graphical user interface 290 displays the data item. For example, the obfuscation module 270 may replace the title of the data item with a generic title (e.g., “This ad may contain adult content, click here to view it.”) as part of the partially concealing the data item.

The user interface module 280 may present the multiple data items located by the search engine 230 to a user 120 such that each data item of the subset of multiple data items is uniquely presented and the content of each data item is at least partially concealed. In presenting to the user 120, the user interface module 280 may enable the client machine 130 to display the graphical user interface 290.

The user interface module 280 may present the data items of the subset simultaneously with other data items on a user interface, for example as a commingled list of data items from and excluded from the subset. However, for the data items of the subset (e.g., the data items having determinable characteristics), the user interface module 280 may use the partially concealed content generated by the obfuscation module 270. For example, the user interface module 280 may display a warning message requesting a viewer (e.g., user 120) to consent to viewing before showing the data item, where the identification module 250 determines that the data item has the determinable characteristic. After the viewer consents to the viewing, the user interface module 280 may display the original content of the data item without any concealment or restriction. According to an example embodiment, the user interface module 280 may verify that the viewer is an adult by requesting a credit card number from the viewer.

In an example embodiment, wherein the identification module 250 identifies a data item as pay-per-view, the user interface module 280 may cause the graphical user interface 290 to display a message to the user 120 indicating that the data item is a pay-per-view advertisement and may request that the viewer consent to a cost amount. The charge may be charged to an existing account or to a credit or debit card associated with the user 120.

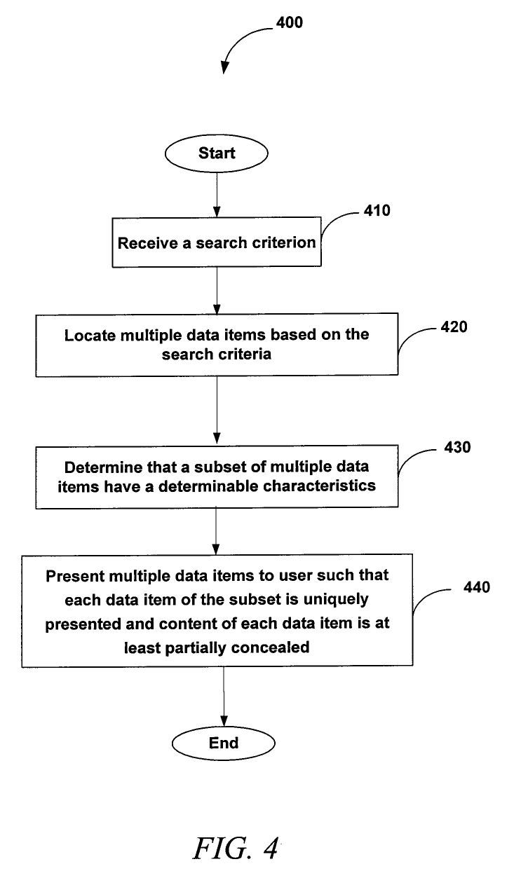

FIG. 4 is a high-level flow diagram illustrating an example method 400 for obscuring of restricted content (e.g., adult content). The method 400 starts at operation 410, where the communication module 220 may receive a search criterion from a user 120 of a publication system. At operation 420, the search engine 230 may search the memory 240 to locate one or more data items based on the search criterion. The identification module 250 may, at operation 430, determine that certain data items have determinable characteristics (e.g., having potentially offensive or illegal content, being pay-per-view (PPV), flagged, or categorized as containing potentially offensive or illegal listings), and include these data items within the subset.

At operation 440, the user interface module 280 may present multiple data items to the user 120, such that each data item is uniquely presented (e.g., presented simultaneously in a commingled manner with other data items on the graphical user interface 290), and content of each data item belonging to the subset is partially or fully concealed.

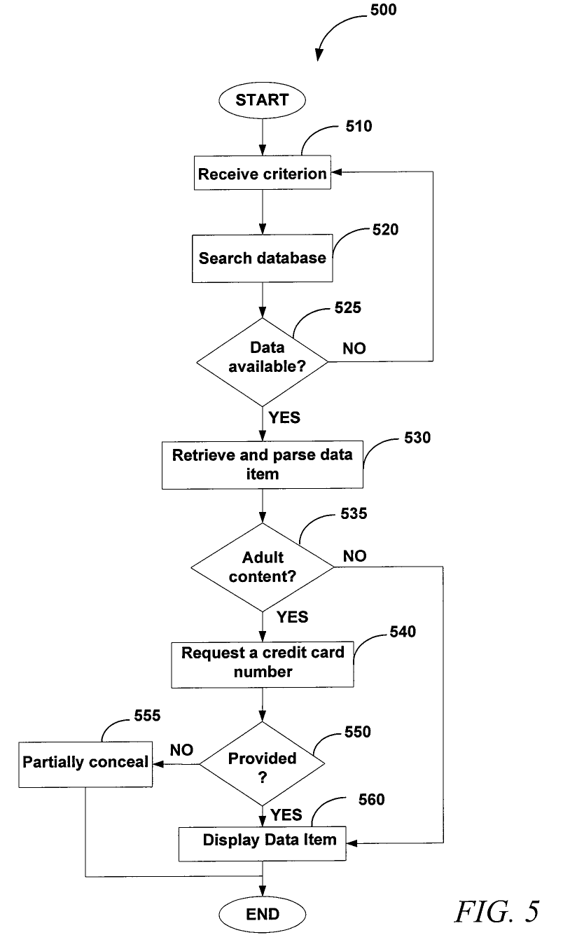

FIG. 5 is a flow diagram illustrating an example method 500 for obscuring of restricted content (e.g., adult content). The method 500 starts at operation 510, where the communication module 220 receives a search criterion. At operation 520, the search engine 230 may search the memory 240 (e.g., a database of the publication system) to locate one or more data items using the search criterion. At control operation 525, if the search engine 230 fails to locate any data item related to the search criterion, control is passed to the operation 510, where a new search criterion may be received.

In an example embodiment, at control operation 525, the search engine 230 may succeed in locating one or more data items. In that case, at operation 530, the data items are retrieved and parsed by the identification module 250. At control operation 535, if it is determined that a subset of the data items have determinable characteristics (e.g., having potentially offensive or illegal content such as adult content, being pay-per-view (PPV), flagged, or categorized as containing potentially offensive or illegal listings), the control may be passed to operation 540, where a credit card number is requested from a viewer to verify that the viewer is an adult. At control operation 550, if a credit card number was provided the user interface module 280 may display the data item to the viewer (operation 560). Otherwise, the control is passed to operation 555, where access to the data items may be controlled or restricted and the data items may be partially or fully concealed by the obfuscation module 270, and the user interface module 280 may only display the partially concealed data items.

In another example embodiment, where the identification module 250 identifies some items as not having determinable characteristic, the user interface module 280 may, at operation 560, present the data items to the user 120, in their original form, without any concealment.

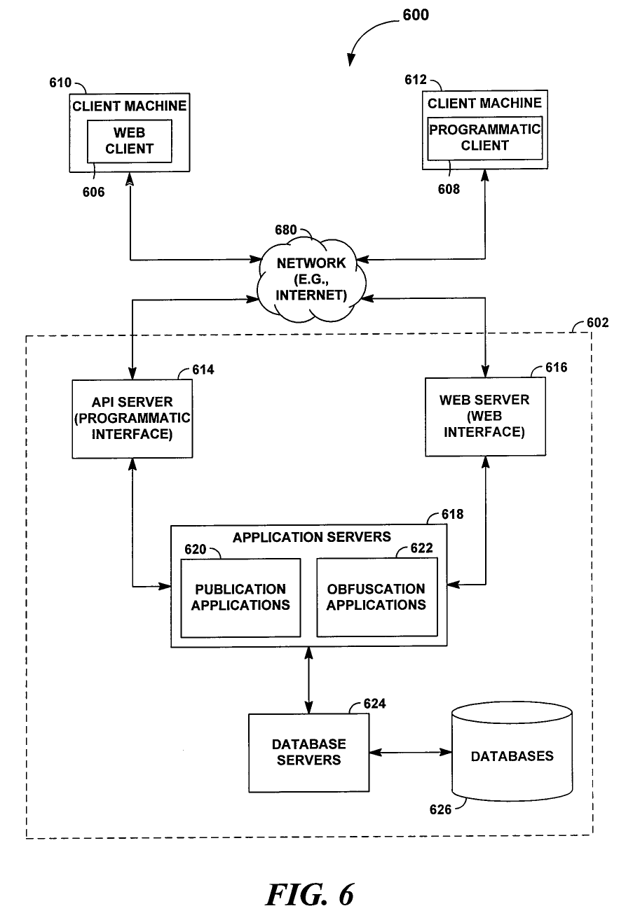

FIG. 6 is high level block diagram illustrating an example embodiment of a network-based publication system 600 enabled for obscuring of restricted content (e.g., adult content), having a client-server architecture. A publication platform, in the example form of an restricted content (e.g., adult content) obscuring server 602, may provide server-side functionality, via a network 680 (e.g., the Internet) to one or more clients. FIG. 6 illustrates, for example, a Web client 606 (e.g., a browser, such as the INTERNET EXPLORER browser developed by Microsoft Corporation of Redmond, Wash.), and a programmatic client 608 executing on respective client machines 610 and 612.

Turning specifically to the restricted content (e.g., adult content) obscuring server 602, an Application Program Interface (API) server 614 and a Web server 616 are coupled to, and provide programmatic and Web interfaces respectively to, one or more application servers 618. The application servers 618 host one or more publication applications 620 and obfuscation applications 622. The application servers 618 are, in turn, shown to be coupled to one or more database servers 624 that facilitate access to one or more databases 626.

The publication applications 620 may provide a number of publication functions and services to users who access the network-based publication system 600. For example, the publication applications may support posting and browsing listings (e.g., items, services, etc.) in the network-based publication system 600. The obfuscation applications 622 may partially or fully conceal one or more data items, retrieved from the databases 626, having determinable characteristics.

Further, while the network-based publication system 600 shown in FIG. 6 employs a client-server architecture, the disclosed system is not limited to such an architecture and could equally well find application in a distributed, or peer-to-peer, architecture system. The various publication and obfuscation applications 620 and 622 could also be implemented as stand-alone software programs, which do not necessarily have networking capabilities.

The Web client 606 may access the publication and obfuscation applications 620 and 622 via the Web interface supported by the Web server 616. Similarly, the programmatic client 608 may access the various services and functions provided by the publication and obfuscation applications 620 and 622 via the programmatic interface provided by the API server 614. The programmatic client 608 may, for example, be a search application to enable buyers to search for listings of interest to the buyers in the network-based publication system 600. In another example embodiment, the programmatic client 608 may support sellers by facilitating posting of one or more items on the network-based publication system 600.

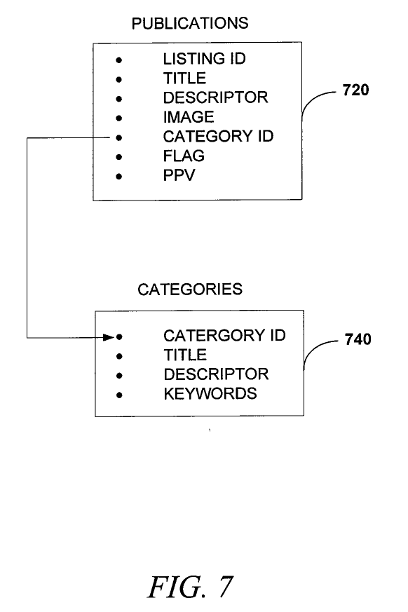

FIG. 7 is a block diagram illustrating an example embodiment of tables used by the databases of the network-based publication system of FIG. 6. Table 720 shows example fields of a publications table. Each publication (e.g., listing, advertisement, or item in a publication system) may have one or more records, each record having fields such as “listing ID,” “title,” “descriptor,” “image,” “category ID,” “flag,” or “PPV”. The listing ID, category ID, title, and descriptor fields may store a unique identification number, a category ID to identify a category that contains the listing, a listing title, and a description of the listing, respectively.

The image field may contain an image of the listing. The flag field may store a flag for the listing. The flag may, for example, show that the poster of the listing has a history of posting listings with potentially offensive or illegal content in non-related categories. When posting a listing, each poster has an option to select the category wherein she/he wants to post the listing. The PPV field may show that the listing is pay-per-view.

Table 740 shows example fields of a category table. Each record of the table may be associated with a category in the publication system. The category ID, title, and descriptor fields may store a unique identification number for the category, a title, and a description of the category, respectively. The keyword field may store relevant keywords related to the category. Keywords may be used to identify one or more categories that a listing in the publication system may be associated with.

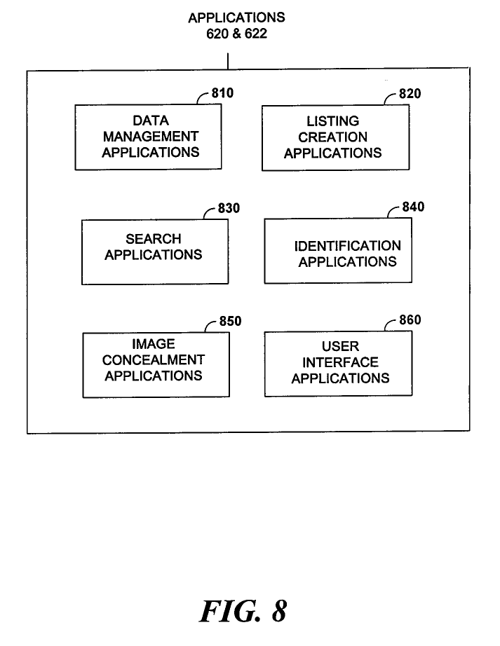

FIG. 8 is an example set of publication and obfuscation applications used by the network-based publication system of FIG. 6. The restricted content (e.g., adult content) obscuring server 602 may provide a number of publication applications 620 and obfuscation applications 622, whereby a user may post a listing or browse published listings in the network-based publication system 600, and any listings having determinable characteristics (e.g., having potentially offensive or illegal content, being pay-per-view, flagged, or categorized as containing potentially offensive or illegal listings) may be partially concealed.

Various data management applications 810 may provide support for handling data, including storing and retrieving data related to various listings published in the network-based publication system 600. The data management applications 810 may arrange for listing data to be categorized into specific categories based on certain keywords.

A number of listing creation applications 820 may allow sellers of items or posters of advertisements to conveniently author listings pertaining to goods or services that they wish to publish via the network-based publication system 600. The listing creation applications 820 may receive input data provided by the sellers or posters, and may have the data management applications 810 store the data in appropriate categories. The listing creation applications 820 may also provide listing information for the user interface applications 860 to display the listings to users.

A number of search applications 830 may support searching the databases 626 of the network-based publication system 600 data items, using search criteria received from a user of the network-based publication system 600. Identification applications 840 may facilitate identification of listings having determinable characteristics by parsing content of titles, descriptors, images, and video portions of listing data.

Image concealment applications 850 may facilitate partial concealment of certain data items identified to have determinable characteristics by, for example, obscuring potentially offensive images, or replacing the images with generic messages notifying a viewer of image characteristics. The image concealment applications 850 may also provide a link to consent to viewing of the potentially offensive image by the viewer.

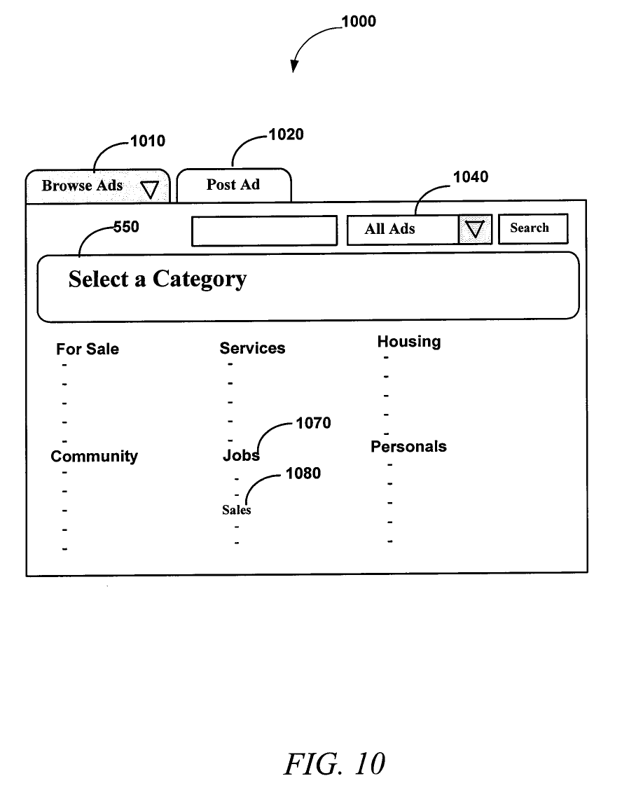

The user interface applications 860 may display various pages (see, for example, FIGS. 10-12) showing, under various categories, published listings of the network-based publication system 600. The user interface applications 860 may also display pages whereby users may post advertisements for items or services in the network-based publication system 600.

### Machine Architecture

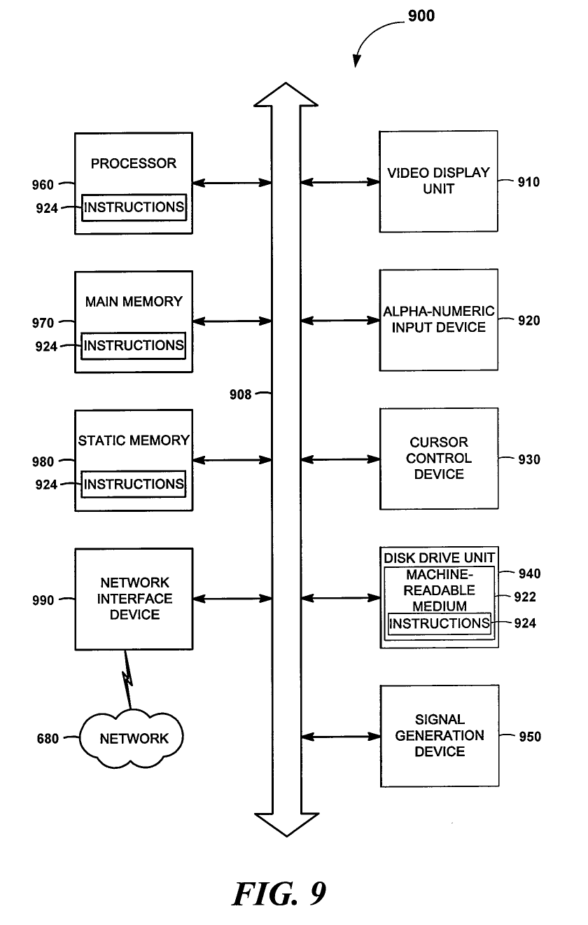

FIG. 9 is a block diagram illustrating a diagrammatic representation of a machine 900 in the example form of a computer system, within which a set of instructions for causing the machine to perform any one or more of the methodologies discussed herein may be executed. In alternative embodiments, the machine 900 may operate as a standalone device or may be connected (e.g., networked) to other machines. In a networked deployment, the machine 900 may operate in the capacity of a server or a client machine in a server-client network environment, or as a peer machine in a peer-to-peer (or distributed) network environment.

The machine 900 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 960 (e.g., a central processing unit (CPU), a graphics processing unit (GPU) or both), a main memory 970 and a static memory 980, all of which communicate with each other via a bus 908. The computer system 900 may further include a video display unit 910 (e.g., a liquid crystal display (LCD) or cathode ray tube (CRT)). The computer system 900 also may include an alphanumeric input device 920 (e.g., a keyboard), a cursor control device 930 (e.g., a mouse), a disk drive unit 940, a signal generation device 950 (e.g., a speaker) and a network interface device 990.

The disk drive unit 940 may include a machine-readable medium 922 on which is stored one or more sets of instructions (e.g., software 924) embodying any one or more of the methodologies or functions described herein. The software 924 may also reside, completely or at least partially, within the main memory 970 and/or within the processor 960 during execution thereof by the computer system 900, with the main memory 970 and the processor 960 also constituting machine-readable media.

The software 924 may further be transmitted or received over a network 680 via the network interface device 990.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

### User Interfaces

FIG. 10 is a screen shot illustrating an example embodiment of a page 1000 for posting advertisements in a publication system. The page 1000 shows a tab 1010 for browsing advertisements that is currently inactive, and a tab 1020 for posting advertisements that has been selected by a user and is currently active. The user may select a category that is most relevant to a listing (e.g., advertisement) for posting the listing in the publication system. The user may select a category by either choosing from the drop-down box 1040 or by clicking on one of the categories listed under category select section 550, for example a sales category 1080 under jobs category group 1070. Once a category is selected, the user may be directed to an appropriate page where he/she may post a listing by providing a title, a price, and a description.

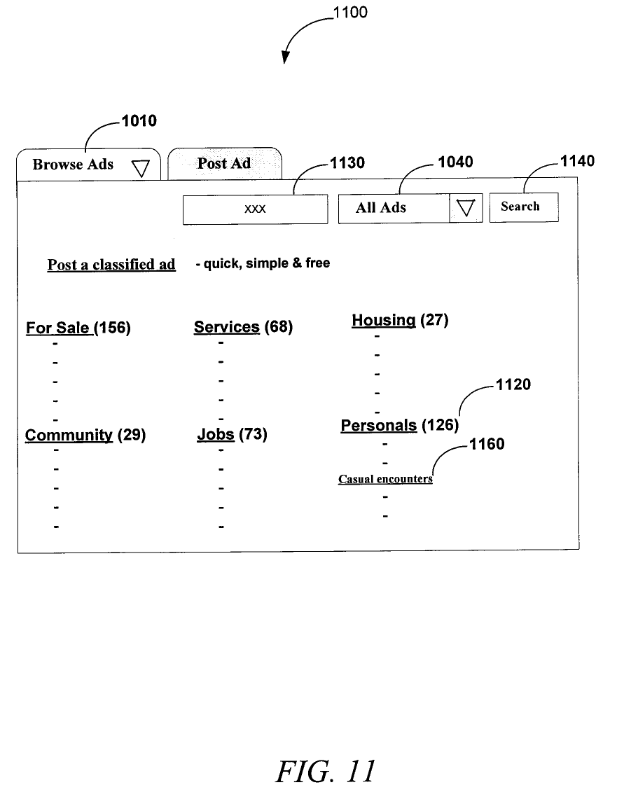

FIG. 11 is a screen shot illustrating an example embodiment of a page 1100 for browsing advertisements in a publication system. The browse ads tab 1010 is currently active, and a user may select a category by either choosing from the drop-down box 1040 or by clicking on one of the listed categories, such as casual encounters category 1160 under personals category group 1120. The numbers displayed in parentheses following a category group name may represent the number of advertisements listed under that category group. Once a category is selected, the user may type a search criterion (e.g., “xxx”) in a search box 1130 and may click on a search button 1140 to search the publication system for items or advertisements related to that search criterion.

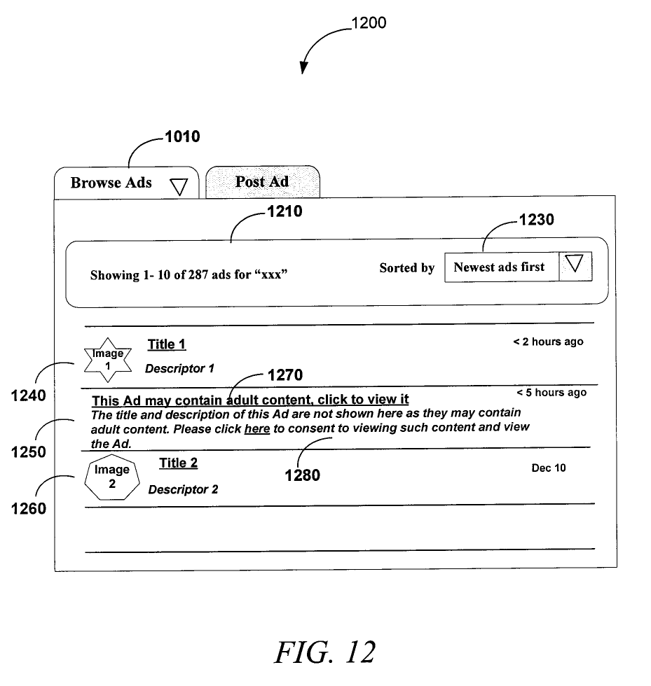

FIG. 12 is a screen shot illustrating an example embodiment of a page 1200 for viewing selected advertisements in a publication system. In response to the search with the search criterion “xxx” typed in the search box 1130 (see FIG. 11), the page 1200 is shown. In the illustrated page, the browse ads tab 1010 is still active. The page 1200 may include a description box 1210 indicating that 1-10 of the 287 advertisements for the search criterion “xxx” are shown in the page.

The user may sort the displayed advertisements by selecting from a “sorted by” configuration (e.g., newest ads first, oldest ads first, lowest price first, etc.) from a sort by box 1230. In the example embodiment shown, one of the advertisements (1250) has determinable characteristics (e.g., having potentially offensive or illegal content, being pay-per-view, flagged, or categorized as containing potentially offensive or illegal listings). This advertisement is displayed simultaneously with other advertisements (1240 and 1260). However, the advertisement 1250 is partially concealed. For example, instead of showing an image, a title, and a descriptor to specifically describe the advertisement, as in the case of other advertisements 1240 and 1260, a generic title 1270 and a generic descriptor 1280 are shown for the advertisement 1250.

In an example embodiment, the generic title 1270 may read “This Ad may contain adult content, click to view it.” The generic title 1270 may be a hypertext link, whereby the user may be directed to a consent page, where the user may confirm his/her age and may consent to viewing the advertisement. The generic descriptor 1280 may refrain from describing the actual advertisement and may, for example, describe why the actual title and description of the advertisement are not shown and direct the user to a link (e.g., the hypertext “here” in the text of the generic descriptor 1280) where the advertisement may be viewed. In other example embodiments, an offensive or illegal image may be obscured or distorted by changing the colors or the contrast of the image.

Accordingly, as opposed to preventing an advertisement with offensive content from displaying entirely, example methods described in this application may be used to uniquely present each advertisement, regardless of the content, by partially or fully concealing the advertisements that have determinable characteristics, but nonetheless presenting information identifying the advertisement to the user. In this way, the user can be alerted to the existence of the advertisement (or other content) while not actually being exposed to the content until, for example, certain restriction prerequisites have been fulfilled.

Thus, a method and a system for obscuring of restricted content (e.g., adult content) have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computerized method comprising:
receiving a search criterion;
locating a plurality of data items using the search criterion;
determining that each data item in a subset of the plurality of data items has at least one determinable characteristic selected from a list of determinable characteristics; and
presenting the plurality of data items to a user such that each data item in the subset is uniquely presented and content of each data item in the subset is at least partially concealed.

2. The computerized method of claim 1, including receiving the search criterion at a publication system.

3. The computerized method of claim 1, wherein the locating of the plurality of data items includes locating at least one of:
a listing, or
an advertisement.

4. The computerized method of claim 1, wherein the list of determinable characteristics includes at least one of:
offensive to a demographic of user,
illegal,
pay-per-view,
flagged as undesirable, or
categorized in a particular category.

5. The computerized method of claim 1, wherein the uniquely presenting of each data item in the subset includes simultaneous presentation of the subset with other data items of the plurality of data items on a graphical user interface.

6. The computerized method of claim 1, including presenting a warning message requesting a viewer to consent to viewing before presenting a data item, if a determination is made that the data item has at least one determinable characteristic.

7. The computerized method of claim 1, wherein the at least partial concealing of the content of each data item in the subset includes obscuring an image contained in the content of the data item.

8. The computerized method of claim 7, wherein the obscuring of the image includes replacing the image with a generic message.

9. The computerized method of claim 7, wherein the obscuring of the image includes distorting the image.

10. The computerized method of claim 8, wherein the generic message notifies a viewer of an image characteristic and provides a link to consent to viewing of the image by the viewer.

11. The computerized method of claim 10, including displaying the image after at least one of:
the viewer consents to the viewing of the image or
a credit card number is received from the viewer.

12. The computerized method of claim 1, wherein the at least partial concealing of the content of each data item in the subset includes replacing a title associated with the data item with a generic title.

13. The computerized method of claim 12 wherein the generic title includes a warning regarding a content characteristic.

14. The computerized method of claim 1 wherein the partial concealing of the content of each data item in the subset includes replacing a descriptor of the data item with a generic message, the generic message notifying a viewer of the at least one determinable characteristic and at least one of:
providing a link to consent to viewing of the content of the data item or
requesting a credit card number from the viewer.

15. A computerized method comprising:
sending a search criterion to a publication system; and
in response to the sending of the search criterion, receiving a user interface displaying a plurality of data items related to the search criterion such that each data item in a subset of the plurality of data items is uniquely presented and content of each data item in the subset is at least partially concealed.

16. A system comprising:
a communication module to receive a search criterion;
a memory to store information related to a plurality of data items in a plurality of categories;
a search engine to locate a plurality of data items using the search criterion;
an identification module to identify a subset of the plurality of data items having at least one determinable characteristic; and
a user interface module to present the plurality of data items to a user such that each data item in the subset is uniquely presented and content of each data item in the subset is at least partially concealed.

17. The system of claim 16, wherein the identification module is to identify the subset of the plurality of data items having at least one determinable characteristic selected from a list of determinable characteristics, the determinable characteristics including at least one of:
offensive to a demographic of user,
illegal,
pay-per-view,
flagged as undesirable, or
categorized in a particular category.

18. The system of claim 16, wherein the uniquely presenting of each data item in the subset includes simultaneous presentation of the subset on a graphical user interface of the subset with other data items of the plurality of data items.

19. The system of claim 16, wherein the user interface module, responsive to the identification module determining that the data item has at least one determinable characteristic, is to present a warning message requesting a viewer to at least one of:
consent to viewing before showing a data item or
provide a credit card number.

20. The system of claim 16, including an obfuscation module to generate partially concealed content, for each data item in the subset including an image, by at least one of:
obscuring the image, or
replacing the image with a generic message that notifies a viewer of an image characteristic and provides a link to consent to viewing of the image by the viewer.

21. The system of claim 16, including an obfuscation module to partially conceal the content of each data item in the subset, including replacing a title associated with each data item in the subset with a generic title warning regarding a content characteristic.

22. The system of claim 21, wherein the obfuscation module is to replace a descriptor of each data item in the subset with a generic message notifying a viewer of the at least one determinable characteristic and providing a link to consent to viewing of content of a data item or requesting a credit card number before the user interface displays the data item.

23. A machine-readable medium comprising instructions, which when implemented by one or more processors, perform operations including:
receiving a search criterion;
locating a plurality of data items using the search criterion;
determining that each data item in a subset of the plurality of data items has at least one determinable characteristic; and
presenting the plurality of data items to a user such that each data item in the subset is uniquely presented and content of each data item in the subset is at least partially concealed.

24. The medium of claim 23, wherein the operations further include:
identifying the subset of the plurality of data items having at least one determinable characteristic selected from a list of determinable characteristics, wherein the list of determinable characteristics includes at least one of:
potentially offensive,
potentially illegal,
pay-per-view,
flagged, or
categorized in a category;
wherein the uniquely presenting of each data item in the subset includes simultaneous presentation of the data items in the subset with other data items of the plurality of data items on a graphical user interface; and
wherein partially concealing content of a data item in the subset includes replacing a title associated with the data item with a generic title.

25. A system comprising:
means for receiving a search criterion;
means for locating a plurality of data items using the search criterion;
means for determining that a subset of the plurality of data items have at least one determinable characteristic; and
means for presenting the plurality of data items to a user such that each data item in the subset is uniquely presented and content of each data item in the subset is at least partially concealed.

26. Apparatus comprising:
a processor; and
a memory, coupled to the processor, storing instructions to cause the processor to:
receive a search criterion;
locate a plurality of data items using the search criterion;
determine that each data item in a subset of the plurality of data items has at least one determinable characteristic; and
present the plurality of data items to a user such that each data item in the subset is uniquely presented and content of each data item in the subset is at least partially concealed.
